(19) United States
(12) Patent Application Publication
(10) Pub. No.: US 2008/0138245 A1
(43) Pub. Date: Jun. 12, 2008

(54) PLASTIC MICROCHIP FOR MICROPARTICLE ANALYSIS AND METHOD FOR MANUFACTURING THE SAME

(76) Inventors: Hyun Jin Kim, Yongin-si (KR); Sin Kil Cho, Seoul (KR)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 11/945,576

(22) Filed: Nov. 27, 2007

(30) Foreign Application Priority Data
Dec. 6, 2006 (KR) 10-2006-0122799

(51) Int. Cl. G01N 15/00; B29C 45/16; B29C 33/38; B29D 31/00

(52) U.S. Cl. 422/68.1; 264/250; 264/227

(57) ABSTRACT

Disclosed herein are a plastic microchip used in counting the number of microparticles and including direction indicators and a method for manufacturing the same. The plastic microchip includes a negative microgrid pattern formed on a lower substrate and direction indicators indicating the position of the microgrid pattern and formed in the vicinity of the microgrid pattern. The method for manufacturing the plastic microchip includes injection-molding a lower substrate including a negative microgrid pattern and direction indicators formed in the vicinity of the negative microgrid pattern, and injecting a solvent through solvent inlets so as to fix an upper substrate to the lower substrate. Accordingly, the present invention provides a plastic microchip including the direction indicators indicating the position of the microgrid pattern and formed on the lower substrate so that an observer can readily find the microgrid pattern through a microscope, thus facilitating the observation of a sample.

### CROSS-REFERENCE TO RELATED APPLICATION

This application claims the benefit of Korean Patent Application No. 10-2006-0122799, filed on Dec. 6, 2006, the entire disclosure of which is hereby incorporated by reference.

### BACKGROUND OF THE INVENTION

1. Field of the Invention

The present invention relates to a plastic microchip used in counting or observing microparticles included in a sample of liquid phase and a method for manufacturing the same. More particularly, the present invention relates to a plastic microchip including a negative microgrid pattern adapted for counting the number of microparticles and direction indicators provided in the vicinity of the negative microgrid pattern, and a method for manufacturing the plastic microchip in which a solvent welding process is employed in fixing an upper substrate to a lower substrate.

2. Description of Related Art

In general, microparticles are particles between 1 to 100 μm in size included in a solution or an organic solvent.

Such microparticles may be exemplified by blood cell colonies such as red blood cells, white blood cells, platelets, etc. contained in blood, cell colonies contained in urine, saliva, spinal fluid, etc., yeast colonies in fermented foods such as beer, bacterial colonies and nanoplanktons contained in solution, cells and impurities contained in suspension such as juice, ketchup, milk, etc., mammalian germ cell colonies, impurities contained in incompletely dissolved suspension, various metal and nonmetal crystals contained in solution or solvent, and so on.

Meanwhile, in order to diagnose diseases such as AIDS, leukemia, anemia, etc., to monitor the development of diseases and to examine the therapeutic effects, the number and function of the typical blood cells such as red blood cells, white blood cells, platelets, etc. contained in blood of patients are analyzed.

For example, chronic leukemia can be diagnosed by the number of platelets, kidney diseases, hypoxia, smoking, pulmonary diseases, hemolytic anemia, aplastic anemia, etc. can be diagnosed by the number of red blood cells, and acute typhlitis, leukemia, aplastic anemia, etc. can be diagnosed by the number of white blood cells.

Like this, the measurement of the number of cells such as hemocytes is closely related to the diagnosis of diseases and, especially, the number of the red blood cells is an essential checkout for identifying an anemia and its cause.

Typically, the sizes of the red blood cells are classified into micro, normal, macro and mega and, the analysis results of the size and number of red blood cells can be used as diagnosis data for various diseases as described above.

A healthy man has red blood cells of about 4.4 to 5.6 million/dl in blood and a healthy woman has red blood cells of about 3.5 to 5 million/dl in blood.

Meanwhile, a plastic microchip has been widely used in observing and counting the microparticles existing in a liquid phase sample, e.g., the blood cells contained in blood.

The plastic microchip comprises a glass, silicon or plastic substrate including a flow path for injecting a sample containing microparticles, formed by anisotropic etching and having a sample inlet formed on one side thereof and a sample outlet established on the other side thereof.

Microparticles existing in the flow path with appropriate width and height in the plastic microchip can be counted using analysis equipment including an optical microscope, a CCD camera, etc.

Hereinafter, a configuration of a plastic microchip and a method for manufacturing the same in accordance with the conventional art will be described with reference to the accompanying drawings.

FIG. 1 is an exploded perspective view of a plastic microchip in accordance with a conventional art, FIGS. 2A and 2B are cross-sectional views of an upper substrate, in which FIG. 2A is a cross-sectional view taken along line A-A of FIG. 1 and FIG. 2B is a cross-sectional view taken along line B-B of FIG. 1. FIG. 3 is an enlarged plan view of a negative microgrid pattern formed on a lower substrate of the plastic microchip depicted in FIG. 1.

As depicted in the figures, the conventional plastic microchip 10a comprises a light transmissive lower substrate 200, on which a negative microgrid pattern 210 for counting the number of microparticles, and a light transmissive upper substrate 100 stacked on the lower substrate 200.

The upper substrate 100 includes an injection chamber 110 formed with a predetermined depth on the bottom surface thereof, a sample inlet 120 formed penetrating the upper substrate 100 to be connected to one side of the injection chamber 110, and a sample outlet 130 formed penetrating the upper substrate 100 to be connected to the other side of the injection chamber 110.

In a state where the upper substrate 100 and the lower substrate 200 are joined to each other, the injection chamber 110 forms a space, in which a sample is filled, together with the top surface of the lower substrate 200 on which the microgrid pattern 210 is formed, and the height of the injection chamber 110 is adjusted according to the volume of the sample to be analyzed.

The sample inlet 120 is directed to a portion to which a sample containing microparticles is injected, and the sample outlet 130 is directed to a portion through which air and an excess of the sample remaining in the injection chamber 110 are discharged during the injection of the sample.

The sample inlet 120 and outlet 130 are formed opposite to each other in the injection chamber 110 of the upper substrate 100 so as to facilitate the injection of the sample. Here, the outlet 130 acts as a vent hole through which air is discharged while the sample is injected into the injection chamber 110. Accordingly, the air in the injection chamber 110 is discharged through the outlet 130, thus facilitating the injection of the sample.

Meanwhile, in the conventional plastic microchip, a solvent channel is formed along the circumference of the injection chamber 110 and solvent inlets 140 including a plurality of openings connected to the solvent channel 150 are formed on the top surface of the upper substrate 100 so that the inner space of the solvent channel 150 is opened upward.

The solvent channel 150 is formed with a groove structure having predetermined height and width along the circumference of the injection chamber 110 on the bottom surface of the upper substrate 100, and the groove structure and the top surface of the lower substrate 200 forms the solvent channel 150 in a state where the upper substrate 100 is stacked on the lower substrate 200.

The solvent channel 150 is formed spaced apart from the circumference of the injection chamber 110 at regular intervals (directed to the thickness of a wall) along the whole circumference of the injection chamber 110, thus forming a wall 160.

Here, the inner surface of the solvent channel 150 corresponding to the outer surface of the wall 160 is formed vertically to the top surface of the lower substrate 200.

The solvent inlets 140 are provided to inject solvent into the solvent channel 150 so as to fix the upper substrate 100 to the lower substrate 200. The solvent inlets 140 are formed spaced apart from each other at regular intervals along the solvent channel 150 on the upper substrate 100.

In order to join the upper substrate 100, on which the solvent inlets 140 and the solvent channel 150 are formed, to the lower substrate 200, the upper substrate 100 is stacked on the lower substrate 200 and then the solvent is injected into the lower corner portion of the solvent channel 150 through the respective solvent inlets 140. Here, the injected solvent flows along the corner portion by a capillary phenomenon and thereby spreads all through the solvent channel 150. As a result, the two substrates 100 and 200 are welded to each other as the solvent penetrates into the interface between the two substrates.

In a state where the solvent is injected as described above, the wall 160 prevents the solvent flowing in along the solvent channel 150 from being introduced into the injection chamber 110 and further prevents the sample injected through the sample inlet 120 into the injection chamber 110 from leaking out of the injection chamber 110.

The solvent channel 150 provides a space through which the solvent injected through the solvent inlets 140 passes.

The injection chamber 110 is formed in a groove structure of a rectangular parallelepiped shape on the bottom surface of the upper substrate 100 and the volume of the injection chamber 110 is calculated from the area and the height (depth of the groove structure) of the injection chamber 110.

Moreover, the sample inlet 120 and the outlet 130 are formed to penetrate the upper substrate 100 vertically on both sides of the injection chamber 110, and the solvent channel 150 of a rectangular path is formed adjacent to the wall 160 along the circumference of the injection chamber 110. Furthermore, six solvent inlets 140 in total are formed in predetermined sections of the solvent channel 150 and thereby the corresponding portions of the top surface of the solvent channel 150 are opened on the upper substrate 100.

The lower substrate 200 includes the microgrid pattern 210 formed in a negative structure on the top surface thereof.

The negative microgrid pattern 210 is established in a predetermined region of the top surface of the lower substrate 200 including the injection chamber 110, and has the shape, depth (d4), width (d2) and interval (d3) depicted in FIGS. 4F and 4G.

The respective grooves of horizontal and vertical microlines constituting the negative microgrid pattern 210 have a width of 4 μm or less and a depth of 1 μm or more. Moreover, the interval (d3) between the grooves is set larger than the width (d2) to be at least 5 μm.

Meanwhile, the substrate region in which the injection chamber 110 is formed in the plastic microchip 10a is formed transparently so as to observe the sample through the microscope. Accordingly, the upper substrate 100 and the lower substrate 200 are made of a light transmissive material.

The upper substrate 100 and the lower substrate 200 are made by an injection molding process using a light transmissive plastic capable of injection molding such as polycarbonate (PC), polymethylmethacrylate (PMMA), polyethylene (PE), polypropylene (PP), polyethyleneterephthalate (PET), polystyrole (PS), cycloolefin (COC) resin, polyolefin (POC) resin, and so on. As the polyolefin resin, Zeon resin, Topas resin, etc. are used.

The process of manufacturing the conventional plastic microchip will be described in detail below.

First, the upper substrate 100 depicted in FIGS. 1, 2A and 2B is formed.

Here, the configuration and materials of the upper substrate 100 are the same as described above and is formed by an ordinary injection molding process.

Next, the lower substrate 200 depicted in FIGS. 1 and 3 is prepared.

Here, the materials of the lower substrate 200 and the microgrid pattern 210 formed in a negative structure are the same as described above and the lower substrate 200 is formed by the injection molding process using a stamper 350 of a metal material on which a positive microgrid pattern 340 is formed.

An injection molding process used in an optical disk (CD) manufacturing process is applied to the process of molding the lower substrate 200. The optical disk manufacturing process is directed to a method in which, after coating photoresist on a glass preform, its shape is moved onto a metal plate called the stamper through exposure, developing and plating processes, and the metal plate is mounted on a mold to obtain a plastic injection-molded product.

FIGS. 4A to 4G are cross-sectional views illustrating respective processes of manufacturing the lower substrate 200 in accordance with the conventional art. Referring to these figures, the process of manufacturing the lower substrate 200 will be described below.

As depicted in FIG. 4A, after preparing a plate 310 made of glass, silicon, ceramic, or the like, a photoresist layer 320 is stacked on the plate 310 by coating photoresist (PR) using a spin coating process.

Next, as depicted in FIG. 4B, the photoresist layer 320 is patterned through exposure and developing processes to form a mask pattern 320a including a negative microgrid pattern on the plate 310.

Subsequently, as depicted in FIG. 4C, a metal such as Cu, Ni, etc. is stacked on the surface, on which the mask pattern 320a is formed, to be charged with electric current using a sputtering, vacuum deposition or electroless plating process, thus forming an electrically conductive metal layer 330.

Then, as depicted in FIG. 4D, a metal such as Cu, Ni, etc. is stacked in a thickness of 0.1 mm or more on the metal layer 330 using an electroless plating or electroplating process, thus forming a stamper 350.

Next, as depicted in FIG. 4E, after separating the plate and the mask pattern, the remaining photoresist is melted with an organic solvent or destroyed by fire to be removed, thus preparing a stamper 350 of a metal material.

The stamper 350 prepared in the form of a thin metal plate is used as a preform for injection molding the lower substrate 200.

Especially, the stamper 350 has a structure in which a positive microgrid pattern 340 is formed in a predetermined region. The positive microgrid pattern 340 used in molding a negative microgrid pattern 210 of a lower substrate 200 to be injection-molded later is formed at a position corresponding to the microgrid pattern 210 of the lower substrate 200.

Subsequently, the stamper 350 is finally completed by performing a series of processes of washing, coating a protective layer, polishing the rear side and cutting to a size capable of being fixed to a mold, and such processes are the same as the method used in the existing optical disk (CD) manufacturing process that is obvious to those skilled in the art.

The stamper 350 is formed with a thickness of about 0.3 mm to ensure the lifespan and durability capable of being mounted on a mold.

Then, as depicted in FIG. 4F, the stamper 350 formed to have the positive microgrid pattern is mounted on the mold and then molten resin that is a material of the lower substrate 200 is injected by an injection molding device, thus forming a lower substrate 200 with a negative microgrid pattern.

Next, as depicted in FIG. 4G, if the mold is removed after the injection molding process, the lower substrate 200 including the negative microgrid pattern 210 is completed.

However, since the above-described conventional plastic microchip includes the microgrid pattern formed in the middle of the lower substrate, it is not easy to find the microgrid pattern during the observation through a high power microscope.

Moreover, since the user does not know the position of the microgrid pattern viewed through the microscope, it is difficult to determine how much he or she moves in which direction.

The information disclosed in this Background of the invention section is only for enhancement of understanding of the background of the invention and should not be taken as an acknowledgement of any form of suggestion that this information forms the prior art that is already known to a person skilled in the art.

### SUMMARY OF THE INVENTION

Accordingly, the present invention has been made in an effort to solve the above-described drawbacks. In one aspect, the present invention provides a plastic microchip in which direction indicators are formed in the vicinity of a microgrid pattern of a lower substrate to indicate the direction of the microgrid pattern while observing a sample through a high power microscope, thus facilitating the observation of the sample, and a method for manufacturing the same.

Moreover, in another aspect, the present invention provides a plastic microchip including direction indicators that indicate the distance or the position of a microgrid pattern, thus readily finding the microgrid pattern while observing a sample through a high power microscope, and a method for manufacturing the same.

In order to accomplish the above objects, one embodiment of the present invention provides a plastic microchip for microparticle analysis comprising light transmissive upper and lower substrates stacked up and down, an injection chamber defined between the upper and lower substrates, a sample inlet connected to one side of the injection chamber, an outlet connected to the other side of the injection chamber, and a microgrid pattern formed on the top surface of the lower substrate, for counting the number of microparticles in a sample contained in the injection chamber, wherein direction indicators for indicating the direction of the microgrid pattern are formed in the vicinity of the microgrid pattern formed on the top surface of the lower substrate.

Here, each of the direction indicators may have a shape of an arrow or a triangle.

Moreover, each of the direction indicators may indicate numerals showing the distance of the microgrid pattern on a side thereof.

Furthermore, each of the direction indicators may indicate coordinates showing the position of the microgrid pattern on a side thereof.

Meanwhile, one embodiment of the present invention provides a method for manufacturing a plastic microchip for microparticle analysis including light transmissive upper and lower substrates stacked up and down, an injection chamber formed between the upper and lower substrates, a sample inlet connected to one side of the injection chamber, an outlet connected the other side of the injection chamber, and a microgrid pattern, formed on the top surface of the lower substrate, for counting the number of microparticles in a sample of the injection chamber, the method comprising the steps of: (a) forming an upper substrate by injection molding a light transmissive plastic; (b) forming a lower substrate including a negative microgrid pattern and direction indicators for indicating the distance or the position of the negative microgrid pattern formed on the top thereof by injection molding a light transmissive plastic; (c) surface-treating the upper substrate and the lower substrate; and (d) welding the upper substrate and the lower substrate to be stacked up and down.

In a preferred embodiment, in step (a), the upper substrate having a groove structure, formed adjacent to a wall provided along the whole circumference of the injection chamber on the bottom surface of the upper substrate, and a plurality of solvent inlets formed to penetrate the top to be opened in the groove structure is molded.

In the preferred embodiment, in step (d), the upper substrate and the lower substrate stacked up and down are solvent-welded by injecting a solvent through the respective solvent inlets into a solvent channel formed by the groove structure and the top surface of the lower substrate, the solvent being injected into a boundary between the upper substrate and the lower substrate.

In a further preferred embodiment step (b) comprises: stacking a photoresist layer on a plate; forming a mask pattern having a negative microgrid pattern and direction indicators on the plate by patterning the photoresist layer through exposure and developing processes; forming an electrically conductive metal layer on the surface on which the mask pattern is formed; forming a stamper of a metal material, on which a positive microgrid pattern and direction indicators are formed, on the metal layer by performing an electroless plating or electroplating; separating the stamper from the mask pattern and washing the stamper separated; processing the resulting stamper through a series of processes of coating a protective layer, polishing the rear side and cutting to a size capable of being fixed to a mold; and obtaining a lower substrate on which a negative microgrid pattern and direction indicators are formed by mounting the processed stamper on the mold and then injection molding.

### BRIEF DESCRIPTION OF THE DRAWINGS

The above and other features of the present invention will be described with reference to certain exemplary embodiments thereof illustrated the attached drawings in which:

FIG. 1 is an exploded perspective view of a plastic microchip in accordance with a conventional art;

FIGS. 2A and 2B are cross-sectional views of an upper substrate of the plastic microchip depicted in FIG. 1, in which FIG. 2A is a cross-sectional view taken along line A-A of FIG. 1 and FIG. 2B is a cross-sectional view taken along line B-B of FIG. 1;

FIG. 3 is an enlarged plan view of a negative microgrid pattern formed on a lower substrate of the plastic microchip depicted in FIG. 1;

FIGS. 4A to 4G are cross-sectional views illustrating a process of forming a lower substrate of the plastic microchip depicted in FIG. 1;

FIG. 5 is an exploded perspective view of another example of the conventional plastic microchip including two injection chambers;

FIG. 6 is an exploded perspective view of a plastic microchip in accordance with the present invention;

FIGS. 7a and 7B are cross-sectional views of an upper substrate, in which FIG. 7A is a cross-sectional view taken along line A-A of FIG. 6 and FIG. 7B is a cross-sectional view taken along line B-B of FIG. 6;

FIG. 8 is an enlarged top view of a negative microgrid pattern and direction indicators formed on the lower substrate of the plastic microchip depicted in FIG. 6;

FIGS. 9A to 9H are cross-sectional views illustrating respective processes of manufacturing the lower substrate in accordance with the present invention; and

FIG. 10 is an exploded perspective view of a plastic microchip in accordance with another embodiment of the present invention including two injection chambers.

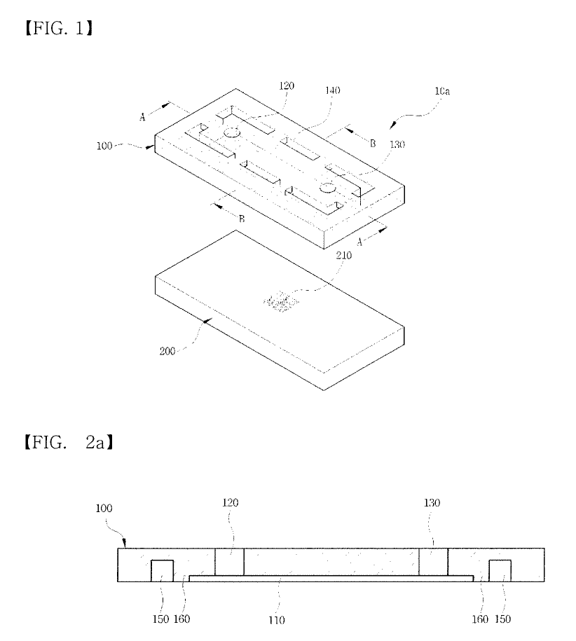

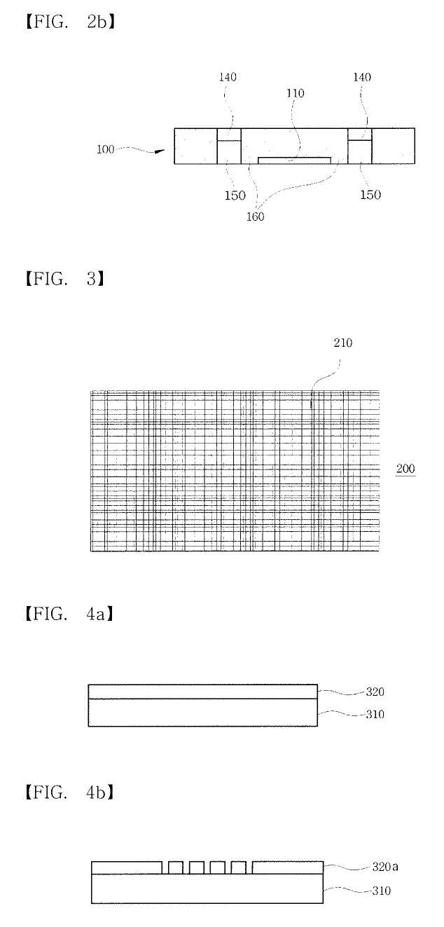

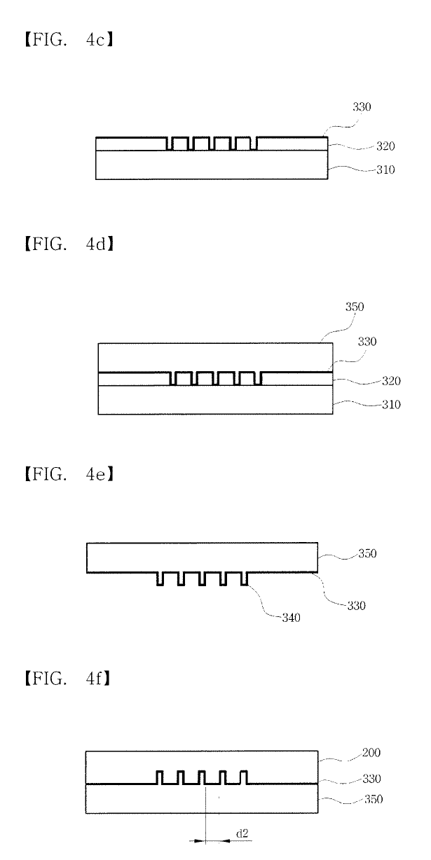

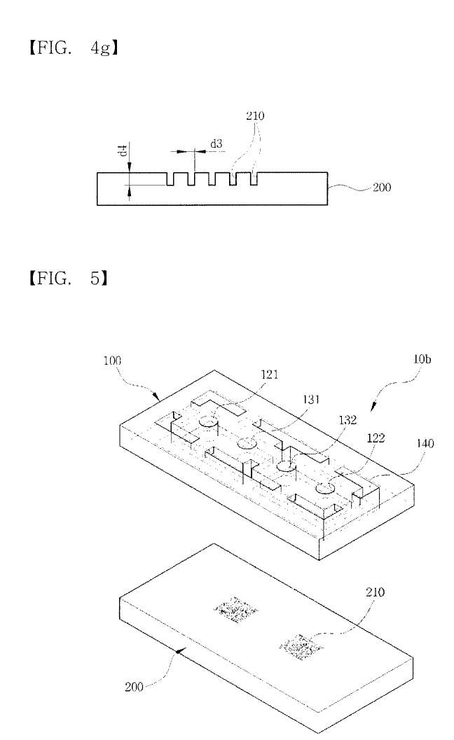

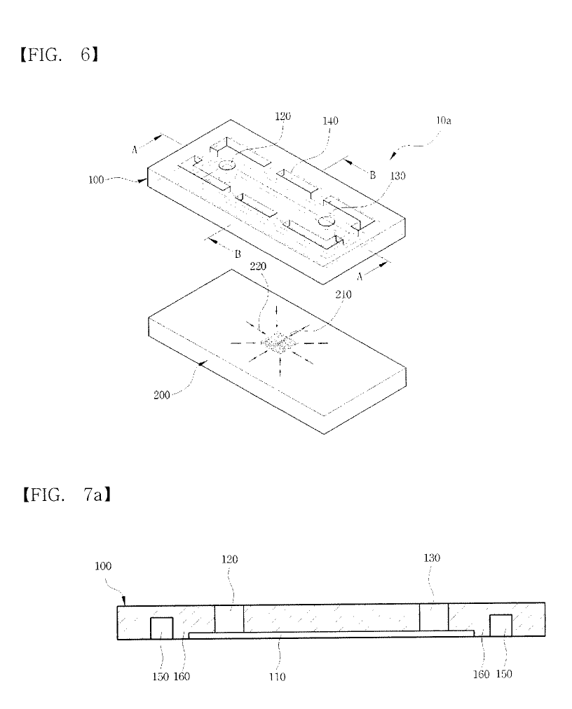

### DETAILED DESCRIPTION OF THE INVENTION

Hereinafter, reference will now be made in detail to the preferred embodiment of the present invention, examples of which are illustrated in the accompanying drawings, wherein like reference numerals refer to like elements throughout.

FIG. 6 is an exploded perspective view of a plastic microchip in accordance with the present invention, FIGS. 7a and 7B are cross-sectional views of an upper substrate, in which FIG. 7A is a cross-sectional view taken along line A-A of FIG. 6 and FIG. 7B is a cross-sectional view taken along line B-B of FIG. 6.

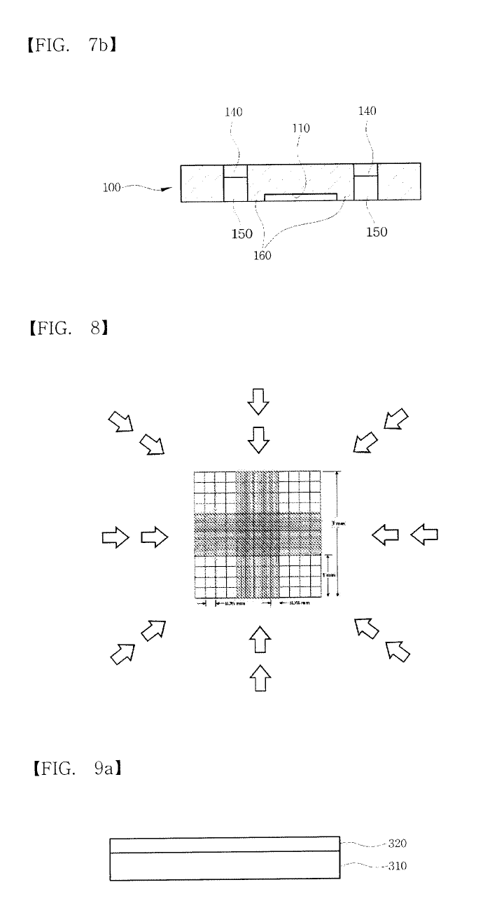

FIG. 8 is an enlarged top view of a negative microgrid pattern and direction indicators formed on the lower substrate of the plastic microchip depicted in FIG. 6.

As depicted in the figures, the plastic microchip 10a in accordance with the present invention comprises a light transmissive lower substrate 200, on which a negative microgrid pattern 210 for counting the number of microparticles and direction indicators 220 for displaying the direction, the distance or the current position of the microgrid pattern 210 are formed, and a light transmissive upper substrate 100 stacked on the lower substrate 200.

Although the upper substrate 100 and the lower substrate 200 separated from each other are depicted in FIG. 6, the plastic microchip 10a of the present invention is provided as an integrated product in which the upper substrate 100 and the lower substrate 200 are stacked and then welded to each other the same as the conventional one.

First, the upper substrate 100 comprises an injection chamber 110 formed in a groove structure of a predetermined depth on the bottom surface thereof, a sample inlet 120 formed penetrating the upper substrate 100 to be connected to one side of the injection chamber 110 and an outlet 130 formed penetrating the upper substrate 100 to be connected to the other side of the injection chamber 110.

In a state where the upper substrate 100 and the lower substrate 200 are joined to each other, the injection chamber 110 forms a space, in which a sample is filled, together with the top surface of the lower substrate 200 on which a microgrid pattern 210 is established. The height of the injection chamber 110 can be adjusted appropriately according to the volume of the sample to be analyzed.

Preferably, the injection chamber 110 is formed 5 to 500 μm in height and, most preferably, 100 μm in height.

The sample inlet 120 is directed to a portion through which a sample including microparticles is injected, and the outlet 130 is directed to a portion through which air and an excess of the sample in the injection chamber 110 are discharged during the injection of the sample.

In a case where the sample inlet 120 and the outlet 130 are connected to the opposite sides in the injection chamber 110 of the upper substrate 100, it is easy to inject the sample into the injection chamber 110. Here, the outlet 130 acts as a vent hole through which the air is discharged during the injection of the sample. Accordingly, as the air in the injection chamber 110 is discharged through the outlet 130, the injection of the sample is made smoothly.

Meanwhile, a solvent channel 150 is formed along the circumference of the injection chamber 110 in the plastic microchip 10a of the present invention. Solvent inlets 140 including a plurality of openings connected to the solvent channel 150 are formed on the top surface of the upper substrate 100 so that the inner space of the solvent channel 150 is opened upward.

The solvent channel 150 is formed in a groove structure having predetermined height and width along the circumference of the injection chamber 110 on the bottom surface of the upper substrate 100. In a state where the upper substrate 100 is stacked on the lower substrate 200, the groove structure and the top surface of the lower substrate 200 form the solvent channel 150.

The solvent channel 150 is formed spaced apart from the circumference of the injection chamber 110 at regular intervals (directed to the thickness of a wall) along the whole circumference of the injection chamber 110, thus forming a wall 160.

Here, the inner surface of the solvent channel 150 corresponding to the outer surface of the wall 160 is formed vertically to the top surface of the lower substrate 200.

The solvent inlets 140 are provided to inject solvent into the solvent channel 150 so as to fix the upper substrate 100 to the lower substrate 200. The solvent inlets 140 are formed spaced apart from each other at regular intervals along the solvent channel 150.

Each of the solvent inlets 140 is established to ensure a sufficient space so that a solvent injection inlet such as a pipette inlet or an injection needle of a solvent injection device may smoothly enter the inside of the solvent channel 150 in the inclined direction.

Here, it is desirable that the width of the solvent inlets 140 be more than 1 mm so that the pipette inlet or the injection needle may smoothly enter a lower corner portion of the solvent channel 150, i.e., the boundary between the outer surface of the wall 160 of the upper substrate 100 and the top surface of the lower substrate 200.

In order to join the upper substrate 100, on which the solvent inlets 140 and the solvent channel 150 are formed, to the lower substrate 200, the upper substrate 100 is stacked on the lower substrate 200 and then the solvent is injected into the lower corner portion of the solvent channel 150 through the respective solvent inlets 140. Here, the injected solvent flows along the corner portion by a capillary phenomenon and thereby spreads all through the solvent channel 150. As a result, the two substrates 100 and 200 are welded to each other as the solvent penetrates into the interface between the two substrates.

In a state where the solvent is injected as described above, the wall 160 prevents the solvent flowing in along the solvent channel 150 from being introduced into the injection chamber 110 and further prevents the sample injected through the sample inlet 120 into the injection chamber 110 from leaking out of the injection chamber 110.

Moreover, since the solvent channel 150 provides a space through which the solvent injected through the solvent inlets 140 passes, it is desirable that the height of the solvent channel 150 in a closed section, of which the top is closed, i.e., in a section other than the solvent inlet section, be more than 0.2 mm so as to make the solvent flow smoothly along the lower corner portion of the solvent channel 150.

Here, if a sufficient height of the solvent channel 150 is not ensured, the solvent may spread over the other peripheral portion than the corner portion to cause a contamination and not to make the solvent flow smoothly, which results in a defective, thereby lowering the productivity.

Referring to a preferred embodiment depicted in FIG. 6, the injection chamber 110 is formed in a groove structure of a rectangular parallelepiped shape on the bottom surface of the upper substrate 100 and the volume of the injection chamber 110 can be calculated from the area and the height (depth of the groove structure) of the injection chamber 110.

Moreover, the sample inlet 120 and the outlet 130 are formed to penetrate the upper substrate 100 vertically on both sides of the injection chamber 110, and the solvent channel 150 of a rectangular path is formed adjacent to the wall 160 along the circumference of the injection chamber 110. Furthermore, six solvent inlets 140 in total are formed in predetermined sections of the solvent channel 150 and thereby the corresponding portions of the top surface of the solvent channel 150 are opened on the upper substrate 100.

Of course, the embodiment depicted in the figure is just an example of the present invention and the present invention is not limited to the depicted embodiment. That is, it is possible to variously modify the shape of the injection chamber 110, the solvent channel 150 and the solvent inlets 140, and to appropriately change the number and position of the solvent inlets 140.

Next, the lower substrate 200 has no difference in the overall shape and structure from the conventional one; however, it has a significant feature in that the microgrid pattern 210 is formed in a negative structure, not a positive structure of the conventional one, on the top surface thereof.

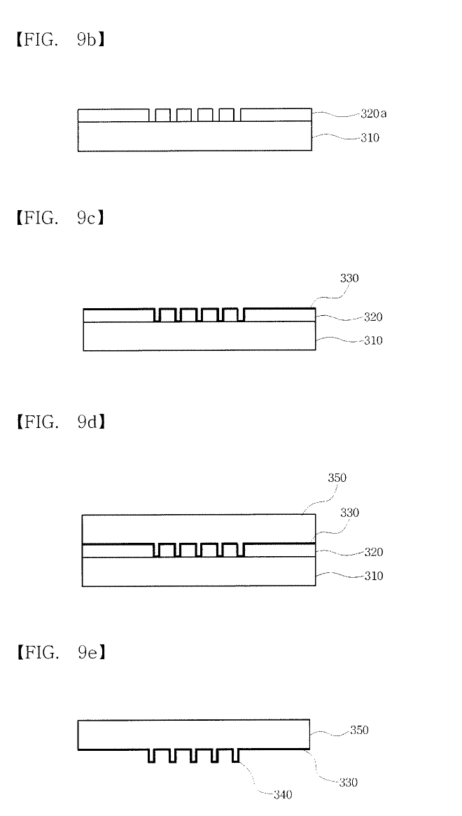

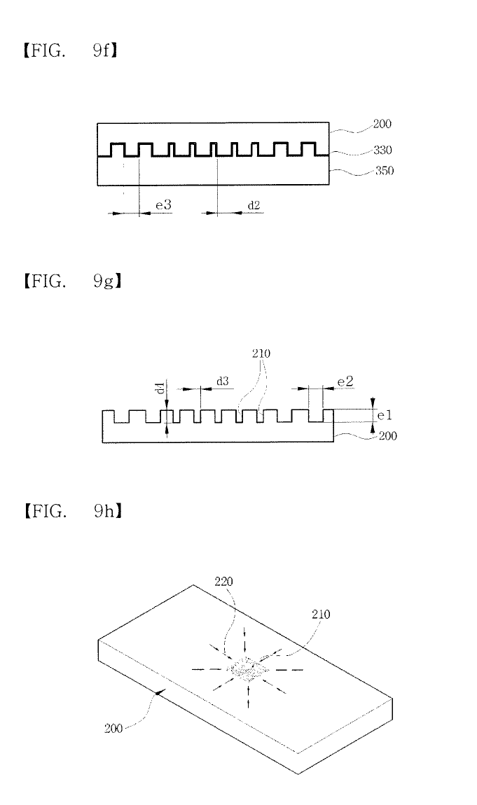

The negative microgrid pattern 210 is established in a predetermined region of the top surface of the lower substrate 200 including the region of the injection chamber 110, and the shape, depth (d4), width (d2) and interval (d3) thereof can be appropriately adjusted, if necessary (see FIGS. 9F and 9G).

Preferably, the respective grooves of horizontal and vertical microlines constituting the negative microgrid pattern 210 have a width of 4 μm or less and a depth of 1 μm or more. Moreover, the interval (d3) between the grooves is set larger than the width (d2) to be at least 5 μm.

Since a user should observe the microgrid pattern 210 in a smaller region to analyze a sample using analysis equipment such as a high power microscope, the smaller the interval (d3) of the microgrid pattern 210, the more convenient it is to observe. Here, it is important that the width (d2) of the microgrid pattern should be set smaller in order to reduce the interval of the microgrid pattern 210.

Moreover, if the depth (d4) of the microgrid pattern 210 is formed deeply, it is possible to look at the microgrid pattern 210 clearly during the observation using the analysis equipment, thus facilitating the observation of the sample.

The present invention provides a plastic microchip 10a in which the direction indicators 220 for displaying the direction, the distance or the current position of the microgrid pattern 210 are formed in the vicinity of the negative microgrid pattern 210 formed on the top surface of the lower substrate 200.

The direction indicators 220 are formed in the vicinity of the negative microgrid pattern 210 formed on the top surface of the lower substrate 200 including the region of the injection chamber 110, and the shape, depth (e1), width (e2) and interval (e3) thereof can be appropriately adjusted, if necessary (see FIGS. 9G and 9H).

Preferably, each of the direction indicators 220 has a shape capable of indicating the direction such as an arrow, triangle, etc., and has a depth of 1 μm or more.

Here, it is desirable that the direction indicators 220 be arranged radially toward the center of the microgrid pattern 210, that is, arrows or triangles are directed toward the microgrid pattern 210.

Each of the direction indicators 220 may be formed with a size of 50 to 500 μm in length and width, respectively.

Since the plastic microchip 10a of the present invention includes the direction indicators 220 for indicating the microgrid pattern 210 formed in the vicinity of the conventional microgrid pattern, it is possible to readily find the microgrid pattern through analysis equipment such as a high power microscope during the observation of the sample.

The process of manufacturing the lower substrate 200 on which the negative microgrid pattern 210 and the direction indicators 220 are formed will be described later.

Meanwhile, the substrate region in which the injection chamber 110 is formed in the plastic microchip 10a should be formed transparently so as to observe the sample through the microscope. Accordingly, the upper substrate 100 and the lower substrate 200 are made of any light transmissive material.

Preferably, the upper substrate 100 and the lower substrate 200 are made by an injection molding process using any light transmissive plastic capable of injection molding such as polycarbonate (PC), polymethylmethacrylate (PMMA), polyethylene (PE), polypropylene (PP), polyethyleneterephthalate (PET), polystyrole (PS), cycloolefin (COC) resin, polyolefin (POC) resin, and so on. As the polyolefin resin, Zeon resin, Topas resin, etc. can be used.

Here, the light transmittance denotes that, when a light having a wavelength of 100 to 2,500 nm penetrates any material such as glass, plastic, etc., a transmittance of a specific region of the above wavelength band has 5% to 100%. The reason why such materials have the light transmittance is that the light of the above wavelength should penetrate the materials in order to facilitate analysis of microparticles such as cells, impurities, crystals, etc. with a naked eye or using analysis equipment.

The process of manufacturing the plastic microchip of the present invention will be described in detail below.

First, the upper substrate 100 depicted in FIGS. 6, 7A and 7B is formed.

Here, the configuration and materials of the upper substrate 100 are the same as described above and may be formed by an ordinary injection molding process.

Next, the lower substrate 200 depicted in FIGS. 6 and 8 is prepared.

Here, the materials of the lower substrate 200, the microgrid pattern 210 formed in a negative structure and the direction indicators 220 are the same as described above and the lower substrate 200 may be formed by an injection molding process using a stamper 350 of a metal material on which a positive microgrid pattern 340 and direction indicators 360 are formed.

An injection molding process used in an optical disk (CD) manufacturing process may be applied to the process of molding the lower substrate 200.

The optical disk manufacturing process is directed to a method in which, after coating photoresist on a glass preform, its shape is moved onto a metal plate called the stamper through exposure, developing and plating processes, and the metal plate is mounted on a mold to obtain a plastic injection-molded product.

FIGS. 9A to 9H are cross-sectional views illustrating respective processes of manufacturing the lower substrate 200 in accordance with the present invention. Referring to these figures, an example of the process of manufacturing the lower substrate 200 will be described in detail below.

As depicted in FIG. 9A, after preparing a plate 310 made of glass, silicon, ceramic, or the like, a photoresist layer 320 is stacked on the plate 310 by coating photoresist (PR) using a spin coating process, for example.

Next, as depicted in FIG. 9B, the photoresist layer 320 is patterned through exposure and developing processes to form a mask pattern 320a including the negative microgrid pattern and the direction indicators on the plate 310.

Subsequently, as depicted in FIG. 9C, a metal such as Cu, Ni, etc. is stacked on the surface, on which the mask pattern 320a is formed, to be charged with electric current using a sputtering, vacuum deposition or electroless plating process, thus forming an electrically conductive metal layer 330.

Then, as depicted in FIG. 9D, a metal such as Cu, Ni, etc. is stacked in a thickness of 0.1 mm or more on the metal layer 330 using an electroless plating or electroplating process, thus forming a stamper 350.

Here, if the metal is stacked in a thickness of 0.1 mm or less, it is difficult to mount the stamper 350 on a mold and thereby the injection molding process is not available.

Next, as depicted in FIG. 9E, after separating the plate and the mask pattern, the remaining photoresist is melted with an organic solvent or destroyed by fire to be removed, thus preparing a stamper 350 of a metal material.

The stamper 350 prepared in the form of a thin metal plate is used as a preform for injection molding the lower substrate 200.

Especially, the stamper 350 has a structure in which the positive microgrid pattern 340 and the direction indicators 220 are formed in predetermined regions. The positive microgrid pattern 340 and the direction indicators 360 used in molding a negative microgrid pattern 210 and direction indicators 220 of a lower substrate 200 to be injection-molded later is formed at positions corresponding to the microgrid pattern 210 and the direction indicators 220 of the lower substrate 200.

Subsequently, the stamper 350 is finally completed by performing a series of processes of washing, coating a protective layer, polishing the rear side and cutting to a size capable of being fixed to a mold, and such processes are the same as the method used in the existing optical disk (CD) manufacturing process that is obvious to those skilled in the art.

It is desirable that the stamper 350 be made in a thickness of about 0.3 mm to ensure the lifespan and durability capable of being mounted on a mold.

Then, as depicted in FIG. 9F, the stamper 350 formed to have the positive microgrid pattern and the direction indicators is mounted on the mold and then molten resin that is a material of the lower substrate 200 is injected by an injection molding device, thus forming a lower substrate 200 with the negative microgrid pattern and the direction indicators.

Next, as depicted in FIG. 9G, if the mold is removed after the injection molding process, the lower substrate 200 including the negative microgrid pattern 210 is completed. Like this, the lower substrates 200 can be manufactured in a large quantity by repeating such an injection molding process.

Moreover, as depicted in FIG. 9H, the lower substrate 200 includes the direction indicators 220 having a shape of an arrow and formed in the vicinity of the microgrid pattern 210.

Here, in the process of manufacturing the lower substrate 200, the width (d3), depth (d4) and interval (d2) of the microgrid pattern 210 are the same as described above.

That is, as a preferred embodiment, the respective grooves of the microlines constituting the negative microgrid pattern 210 have a width of 4 μm or less and a depth of 1 μm or more. Moreover, the interval (d2) between the grooves is set larger than the width (d3) to be at least 5 μm.

Moreover, each of the direction indicators 220 has a shape capable of indicating the direction such as an arrow, triangle, etc., and has a depth of 1 μm or more. The interval (e3) between the direction indicators 220 is set larger than the width (e2) to be at least 500 μm.

Next, the upper substrate 100 and the lower substrate 200 manufactured as described above are fixed to each other to complete the plastic microchip 10a, and the fixing process will be described below.

It is desirable that the upper substrate 100 and the lower substrate 200 be formed in a body by welding the corresponding surfaces thereof to form a stacked structure rather than using a method of using separate fixing means. Here, they may be welded to each other by an ordinary method, such as heating, using an adhesive, coating, pressurizing, vibrating, ultrasonic welding, etc. Preferably, a solvent welding process, in which a solvent, an adhesive or a mixture thereof is injected to a boundary between the two substrates through the solvent inlets 140 and the solvent channel 150, is used.

First, it is desirable that a surface treatment process for the upper substrate 100 and the lower substrate 200 be performed prior to the solvent welding process to increase the solvent flow rate. If the surface energy is increased through the surface treatment, the solvent flow rate is increased and thereby the connection state and force may be increased.

Moreover, if the upper substrate 100 and the lower substrate 200 are subjected to the surface treatment, the sample can smoothly flow along the flow path from the sample inlet 120, the injection chamber 110 to the outlet 130.

In the surface treatment process, the surfaces of the upper substrate 100 and the lower substrate 200 are subjected to hydrophilic and functional treatments using a surface treatment apparatus. Here, it is desirable to apply a surface modification process such as hydrophilic treatment, introduction of reactive groups, etc. using a plasma surface treatment apparatus that injects gas such as oxygen, nitrogen, argon, ammonia, etc. in a space under a low vacuum condition and, at the same time, applies a high voltage thereto.

If the plastic microchip 10a in accordance with the present invention is subjected to an oxygen plasma treatment so that it shows hydrophilic characteristics, an aqueous liquid such as blood can flow well in the injection chamber 110 and further spreads uniformly.

For example, in the case of the hydrophilic treatment, the plastic microchip 10a is subjected to a plasma discharge treatment for 250 to 350 seconds by injecting oxygen gas of about 180 to 200 cm³/min.

Moreover, in order to introduce a desired reactive group, e.g. an amine group, it is possible to surface-treat the plastic microchip 10a by a plasma treatment with the amine-reactive group or by other chemical processes.

Like this, if the plastic microchip 10a is subjected to the surface treatment, it can be used in constituting a protein chip, a DNA chip, etc., and their performance is improved more and more.

Meanwhile, in order to fix the upper substrate 100 and the lower substrate 200 subjected to the surface treatment as described above to each other, the two substrates 100 and 200 are stacked up and down and then the solvent is injected into the lower corner portion of the solvent channel 150, i.e., the boundary between the outer surface of the wall 160 of the upper substrate 100 and the top surface of the lower substrate 200, using a solvent injection device such as a pipette, an injection needle, etc. as described above.

Here, the solvent is injected through the respective solvent inlets 140 and the injected solvent flows from the outer surface of the wall 160 along the corner portion by a capillary phenomenon and thereby spreads all through the solvent channel 150.

As the solvent in the above-described welding process, any organic solvent, adhesive or mixture thereof that can melt the materials of the upper substrate 100 and the lower substrate 200 may be used.

For example, it is possible to use at least one selected from the group consisting of ketones, aromatic hydrocarbons and halogenated hydrocarbons and, preferably, at least one selected from the group consisting of acetone, chloroform, methylene chloride and carbon tetrachloride is used.

Moreover, it is also possible to use a predetermined amount of adhesive such as acryl resin by mixing with the solvent or a mixture.

As described in detail above, if the solvent welding process is used in welding the upper substrate 100 and the lower substrate 200 to each other, it is possible to provide the height of the injection chamber 110 uniformly compared with the conventional process such as heating, using an adhesive, coating, pressurizing, vibrating, ultrasonic welding, etc.

Especially, if using the solvent welding process, it is possible to form the injection chambers 110 with a uniform height controlled by the injection molding, since there is no change in the shape of the upper substrate 100 before and after the welding process compared with the convention ultrasonic welding process.

Like this, after the welding process of the upper substrate 100 and the lower substrate 200, a desired plastic microchip 10a is completed.

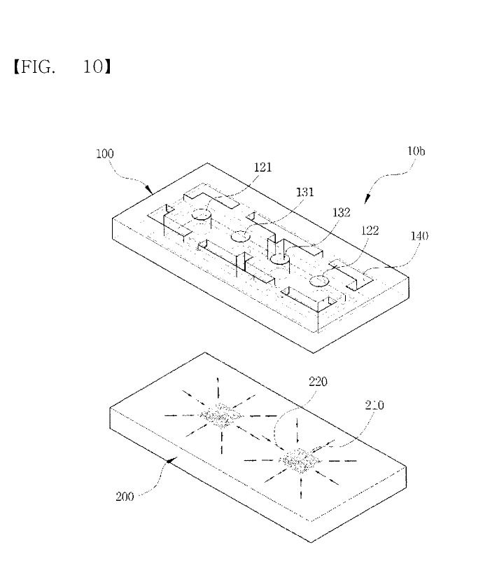

FIG. 10 is an exploded perspective view of another embodiment of the present invention including two injection chambers.

As depicted in the figure, the plastic microchip 10b in accordance with another embodiment of the present invention includes two injection chambers, depicted in hidden lines divided by a wall. Each of the injection chambers includes a separate sample inlet 121 and 122 and an outlet 131 and 132.

Moreover, the solvent channels for the solvent welding, depicted in hidden lines, are formed along the circumference of the injection chambers in the upper substrate 100, and a plurality of solvent inlets 140 is formed at regular intervals along the respective solvent channels.

Like this, the plastic microchip 10b in accordance with the present invention can include more than two injection chambers, if necessary.

Here, each of the injection chambers has an independent space in which the microgrid pattern and the direction indicators are arranged, respectively.

The plastic microchip of the present invention manufactured as described above can readily count the number of red blood cells, white blood cells, platelets, etc. contained in blood and cells contained in a sample such as spinal fluid, urine, saliva, milk etc. and further facilitate the counting and observation of mammalian germ cells.

Moreover, it is also possible to readily count the number of unicellular organisms such as bacteria, yeasts, etc., impurities contained in incompletely dissolved suspension, various metal and nonmetal crystals and any other microparticles.

As described above, the plastic microchip and the method for manufacturing the same in accordance with the present invention provide the following advantages:

(1) With the direction indicators for indicating the direction of the microgrid pattern provided in the vicinity of the microgrid pattern, it is possible to readily find the microgrid pattern being used for the observation of the sample; and

(2) With the direction indicators for indicating the direction or the position of the microgrid pattern, it is possible to readily find the microgrid pattern being used for the observation of the sample, thus reducing the observation time of the same.

As above, preferred embodiments of the present invention have been described and illustrated, however, the present invention is not limited thereto, rather, it should be understood that various modifications and variations of the present invention can be made thereto by those skilled in the art without departing from the spirit and the technical scope of the present invention as defined by the appended claims.

1. A plastic microchip for microparticle analysis comprising light transmissive upper and lower substrates stacked up and down, an injection chamber defined between the upper and lower substrates, a sample inlet connected to one side of the injection chamber, an outlet connected to the other side of the injection chamber, and a microgrid pattern formed on the top surface of the lower substrate, for counting the number of microparticles in a sample contained in the injection chamber, wherein direction indicators for indicating the direction of the microgrid pattern are formed in the vicinity of the microgrid pattern formed on the top surface of the lower substrate.

2. The plastic microchip for microparticle analysis of claim 1, wherein each of the direction indicators has a shape of an arrow or a triangle.

3. The plastic microchip for microparticle analysis of claim 1, wherein each of the direction indicators indicates numerals showing the distance of the microgrid pattern on a side thereof.

4. The plastic microchip for microparticle analysis of claim 1, wherein each of the direction indicators indicates coordinates showing the position of the microgrid pattern on a side thereof.

5. A method for manufacturing a plastic microchip for microparticle analysis including light transmissive upper and lower substrates stacked up and down, an injection chamber formed between the upper and lower substrates, a sample inlet connected to one side of the injection chamber, an outlet connected the other side of the injection chamber, and a microgrid pattern, formed on the top surface of the lower substrate, for counting the number of microparticles in a sample of the injection chamber, the method comprising the steps of:
(a) forming an upper substrate by injection molding a light transmissive plastic;
(b) forming a lower substrate including a negative microgrid pattern and direction indicators for indicating the distance or the position of the negative microgrid pattern formed on the top thereof by injection molding a light transmissive plastic;
(c) surface-treating the upper substrate and the lower substrate; and
(d) welding the upper substrate and the lower substrate to be stacked up and down.

6. The method of claim 5, wherein, in step (a), the upper substrate having a groove structure, formed adjacent to a wall provided along the whole circumference of the injection chamber on the bottom surface of the upper substrate, and a plurality of solvent inlets formed to penetrate the top to be opened in the groove structure is molded; and
wherein, in step (d), the upper substrate and the lower substrate stacked up and down are solvent-welded by injecting a solvent through the respective solvent inlets into a solvent channel formed by the groove structure and the top surface of the lower substrate, the solvent being injected into a boundary between the upper substrate and the lower substrate.

7. The method of claim 5, wherein, step (b) comprises: stacking a photoresist layer on a plate; forming a mask pattern having a negative microgrid pattern and direction indicators on the plate by patterning the photoresist layer through exposure and developing processes; forming an electrically conductive metal layer on the surface on which the mask pattern is formed; forming a stamper of a metal material, on which a positive microgrid pattern and direction indicators are formed, on the metal layer by performing an electroless plating or electroplating; separating the stamper from the mask pattern and washing the stamper separated; processing the resulting stamper through a series of processes of coating a protective layer, polishing the rear side and cutting to a size capable of being fixed to a mold; and obtaining a lower substrate on which a negative microgrid pattern and direction indicators are formed by mounting the processed stamper on the mold and then injection molding.
